(19) United States
(12) Patent Application Publication
(10) Pub. No.: US 2013/0209741 A1
(43) Pub. Date: Aug. 15, 2013

(54) POROUS RESIN SHEET AND METHOD FOR PRODUCING THE SAME

(71) Applicants: Tomoyuki Kasagi, Osaka (JP); Takeshi Sutou, Osaka (JP); Hiroichi Ukei, Osaka (JP)

(72) Inventors: Tomoyuki Kasagi, Osaka (JP); Takeshi Sutou, Osaka (JP); Hiroichi Ukei, Osaka (JP)

(73) Assignee: NITTO DENKO CORPORATION, Ibaraki-shi, Osaka (JP)

(21) Appl. No.: 13/822,068

(22) PCT Filed: Sep. 8, 2011
(86) PCT No.: PCT/JP2011/070507

§ 371 Date: May 1, 2013

(30) Foreign Application Priority Data
Sep. 11, 2010 (JP) 2010-203806
Aug. 31, 2011 (JP) 2011-189696

(51) Int. Cl. B32B 15/08; H01B 3/30

(52) U.S. Cl. CPC B32B 15/08; H01B 3/306
USPC 428/156; 428/220; 428/319.1; 264/50

(57) ABSTRACT

The present invention relates to a porous resin sheet which is a single-layer porous resin sheet including a thermoplastic resin, in which the porous resin sheet has a thickness of 1.0 mm or more, a dielectric constant at 1 GHz of 2.00 or less, a dielectric loss tangent of 0.0050 or less, and an elastic modulus of 200 MPa or more. Also, the present invention relates to a method for producing the porous resin sheet, the method including: a gas impregnation step of impregnating a thermoplastic resin composition containing at least a thermoplastic resin with a non-reactive gas under pressure; and after the gas impregnation step, a foaming step of reducing the pressure to foam the thermoplastic resin composition.

### TECHNICAL FIELD

The present invention relates to a porous resin sheet having low dielectric constant and dielectric loss tangent and a method for producing the same. This porous resin sheet can be utilized as a substrate material over a wide range inclusive of low-dielectric constant materials which are used for high-frequency circuits such as circuit boards and mobile phone antennas, electromagnetic wave control materials such as electromagnetic wave shields and electromagnetic wave absorbers, heat insulating materials, and the like.

### BACKGROUND ART

As a high-frequency circuit board such as a mobile phone antenna, in order to reduce signal transmission loss, a circuit board using a low-dielectric material is considered to be necessary, and for example, a circuit board using a ceramic is used.

An alumina substrate including alumina as a raw material is used as the ceramic substrate and has heat resistance to a solder reflow. However, the alumina substrate involves such problems that it is heavy in weight and that it is liable to break, and substitution with a resin is being advanced. Furthermore, for the purpose of enhancing the signal transmission, the use in a high-frequency region is desired. On that occasion, however, in order to achieve a reduction of the transmission loss, a circuit board using a low-dielectric material becomes needed. In general, the smaller the dielectric constant and the dielectric loss tangent, the smaller the dielectric loss is as expressed according to the following equation, thereby achieving an effect for reducing the transmission loss.

Ad=27.3×f/C×tan δ×\sqrt{∈}

Ad: Dielectric loss

f: Frequency (Hz)

∈: Dielectric constant

C: Speed of light

tan δ: Dielectric loss tangent

In addition, a patch antenna which is used for mobile phone antennas or the like is polyfunctional, lightweight, small-sized, inexpensive, and easy for fabrication, and therefore, it has become an important antenna in communication and engineering applications. At present, a multi-frequency band antenna using some applications by a single antenna has become needed, and this multi-frequency band antenna can be realized by band widening of the bandwidth of a frequency band. However, the patch antenna involved such a drawback that its frequency characteristics are generally narrow.

Accordingly, in the patch antenna, with respect to the antenna configuration, a configuration in which a parasitic radiation patch element is disposed on and coupled with an upper part of a microstrip radiation element, or a method of adding a band widening matching circuit to a power supply line is investigated as means for achieving band widening. In addition, it is also possible to achieve band widening even in substrate materials which are used for the patch antenna, and as for a measure thereof, there are a method of thickening the substrate thickness and a method of using a low-dielectric substrate. However, in the case where the substrate thickness is made thick, in high-dielectric substrates such as ceramic substrates, etc., the dielectric loss is large, and the Q value expressing the sharpness of resonance is high, and therefore, there is involved such a problem that the bandwidth becomes narrow. On the other hand, fluorine substrates which are excellent in dielectric characteristics as a high-frequency substrate are useful as a substrate material of the patch antenna. However, not only the material costs were high, but there was also a problem in processability, such as the use of a special chemical in circuit processing by means of plating or the like, etc. Then, a substrate material with low dielectric and low loss has been demanded in place of the fluorine substrate.

On the other hand, in order to keep low dielectric properties, it is known to lower the dielectric constant by making a substrate film porous. There are porous films using a thermoplastic resin such as polypropylene, polyethylene, etc. as a film having pores, and they accomplish both low dielectric properties and thickening of sheet. However, the heat resistance is not sufficient, and the strength is not sufficient, too. In addition, porous films using a high heat-resistant polymer are investigated; however, though the dielectric constant is sufficiently low, the thickening of sheet was difficult (see Patent Documents 1 and 2). That is, in Patent Document 1, a process for producing a heat-resistant polymer foamed body by impregnating a heat-resistant polymer with a non-reactive gas such as carbon dioxide in a supercritical state and then reducing the pressure, followed by heating at a temperature exceeding 120° C. to foam the polymer is disclosed. However, since the temperature at the time of impregnation is low, the foaming to an extent of realizing the thickening of 1 mm or more is not accomplished. In addition, in Patent Document 2, it is disclosed to obtain an open cell porous body by the wet coagulation method. However, it is not disclosed to obtain a porous body having a thickness of 1 mm or more.

Furthermore, as a method for thickening a thin sheet, it is known to achieve lamination via a sheet and an adhesive layer (see Patent Document 3). According to this, there are revealed results that the thickened sheet obtained through lamination exhibits high values of dielectric constant and dielectric loss tangent as compared with the dielectric constant and dielectric loss tangent of a porous film simple material. However, in the case where the dielectric constant of the adhesive is greatly different from the dielectric constant of the polymer, not only there is involved such a problem that transmission characteristics in a high-frequency region has variation due to a variation in the thickness to be caused by pressurization at the time of lamination, but there is such a drawback that an elastic modulus is weak due to the lamination, so that deformation is liable to occur at the time of substrate processing.

### BACKGROUND ART DOCUMENT

### Patent Document

Patent Document 1: JP-A-2001-55464
Patent Document 2: JP-A-2004-87638
Patent Document 3: JP-A-2000-269616

### SUMMARY OF THE INVENTION

### Problems that the Invention is to Solve

An object of the present invention is to provide a single-layer porous dielectric sheet having a thick film thickness, having low dielectric constant and dielectric loss tangent, and having a high elastic modulus, and a method for producing the same.

### Means for Solving the Problems

Namely, the present invention provides a porous resin sheet which is a single-layer porous resin sheet including a thermoplastic resin, in which the porous resin sheet has a thickness of 1.0 mm or more, a dielectric constant at 1 GHz of 2.00 or less, a dielectric loss tangent of 0.0050 or less, and an elastic modulus of 200 MPa or more.

The porous resin sheet of the invention preferably contains cells having an average cell diameter of 5.0 μm or less, so as to have a porosity of 40% or more, and a scattervariation in the thickness is preferably 10 μm or less.

The thermoplastic resin constituting the porous resin sheet of the invention is preferably any one kind selected from a polyimide and a polyether imide.

The present invention provides a method for producing the porous resin sheet, the method including: a gas impregnation step of impregnating a thermoplastic resin composition containing at least a thermoplastic resin with a non-reactive gas under pressure; and after the gas impregnation step, a foaming step of reducing the pressure to foam the thermoplastic resin composition.

The method for producing a porous resin sheet of the invention preferably includes, after the foaming step, a heating step of heating the porous resin sheet at a temperature of 150° C. or higher.

In the method for producing a porous resin sheet of the invention, carbon dioxide is preferably used as the non-reactive gas.

In the method for producing a porous resin sheet of the invention, it is preferable that the non-reactive gas is impregnated in a supercritical state.

The present invention provides a porous substrate including a metal foil layer on at least one surface of the porous resin sheet.

### Advantage of the Invention

The porous resin sheet according to the present invention can be utilized as a substrate material over a wide range inclusive of low-dielectric constant materials which are used for high-frequency circuits such as circuit boards and mobile phone antennas, electromagnetic wave control materials such as electromagnetic wave shields and electromagnetic wave absorbers, heat insulating bodies, and the like while applying characteristics including thick film thickness, low dielectric constant and dielectric loss tangent, and high elastic modulus. In particular, the porous resin sheet according to the present invention can be used as a patch antenna element substrate material having a wide bandwidth and high antenna characteristics.

### BRIEF DESCRIPTION OF THE DRAWINGS

FIG. 1A is a lateral view of an analysis model for carrying out simulation in the case of applying a porous resin sheet according to the present invention to a patch antenna.

FIG. 1B is a single view drawing of the analysis model shown in FIG. 1A.

### MODE FOR CARRYING OUT THE INVENTION

Embodiments of the present invention are hereunder described. The porous resin sheet according to the present invention is a single-layer porous resin sheet including a thermoplastic resin, which has a thickness of 1.0 mm or more, a dielectric constant at 1 GHz of 2.00 or less, a dielectric loss tangent of 0.0050 or less, and an elastic modulus of 200 MPa or more.

Though the thermoplastic resin which is used in the present invention is not particularly limited, it is preferably a thermoplastic resin having heat resistance. In particular, a thermoplastic resin having heat resistance such that a glass transition temperature thereof is 150° C. or higher is suitably used. Examples of such a thermoplastic resin include a polyamide, a polycarbonate, polybutylene terephthalate, polyethylene terephthalate, polyphenylene sulfide, a polyarylate, a polysulfone, a polyether sulfone, a polyetheretherketone, a polyamide-imide, a polyimide, a polyether imide. The thermoplastic resins can be either alone or in a mixture of two or more kinds thereof.

Among the foregoing polymers, a polyimide and a polyether imide are suitably used. As for a reason why the polyimide or polyether imide is used as the thermoplastic resin in the present invention, there is exemplified the fact that the dimensional stability at high temperatures is good. The polyimide can be obtained by a known or customary method. For example, the polyimide can be obtained by allowing an organic tetracarboxylic acid dianhydride and a diamino compound (diamine) to react with each other to synthesize a polyimide precursor (polyamide acid) and subjecting this polyimide precursor to dewatering cyclization.

Examples of the foregoing organic tetracarboxylic acid dianhydride include pyromellitic dianhydride, 3,3′,4,4′-biphenyltetracarboxylic acid dianhydride, 2,2-bis(2,3-dicarboxyphenyl)-1,1,1,3,3,3-hexafluoropropane dianhydride, 2,2-bis(3,4-dicarboxyphenyl)-1,1,1,3,3,3-hexafluoropropane dianhydride, 3,3′,4,4′-benzophenonetetracarboxylic acid dianhydride, bis(3,4-dicarboxyphenyl)ether dianhydride and bis(3,4-dicarboxyphenyl)sulfone dianhydride. These organic tetracarboxylic acid dianhydrides may be either alone or in a mixture of two or more kinds thereof.

Examples of the foregoing diamino compound include m-phenylenediamine, p-phenylenediamine, 3,4′-diaminodiphenyl ether, 4,4′-diaminodiphenyl ether, 4,4′-diaminodiphenyl sulfone, 3,3′-diaminodiphenyl sulfone, 2,2-bis(4-aminophenoxyphenyl)propane, 2,2-bis(4-aminophenoxyphenyl)hexafluoropropane, 1,3-bis(4-aminophenoxy)benzene, 1,4-bis(4-aminophenoxy)benzene, 2,4-diaminotoluene, 2,6-diaminotoluene, diaminodiphenylmethane, 4,4′-diamino-2,2′-dimethylbiphenyl and 2,2′-bis(trifluoromethyl)-4,4′-diaminobiphenyl.

Incidentally, as for the polyimide which is used in the present invention, it is preferable to use 3,3′,4,4′-biphenyltetracarboxylic acid dianhydride as the organic tetracarboxylic acid dianhydride and p-phenylenediamine or 4,4′-diaminodiphenyl ether as the diamino compound.

In general, the foregoing polyimide precursor is obtained by allowing substantially equal moles of the organic tetracarboxylic acid dianhydride and the diamino compound (diamine) to react with each other in an organic solvent at from 0 to 90° C. for from about 1 to 24 hours. Examples of the foregoing organic solvent include polar solvents such as N-methyl-2-pyrrolidone, N,N-dimethylacetamide, N,N-dimethylformamide and dimethyl sulfoxide.

The dewatering cyclization reaction of the polyimide precursor is, for example, carried out by heating at from about 300 to 400° C. or allowing a dewatering cyclizing agent such as a mixture of acetic anhydride and pyridine to act. In general, the polyimide is a polymer which is insoluble in an organic solvent and hardly moldable. Accordingly, in the case of producing a porous body including a polyimide, for the preparation of a polymer composition having a microphase-separated structure as described above, it is general to use the foregoing polyimide precursor as the polymer.

Incidentally, the polyimide can also be obtained by a method of heat cyclizing a polyamide acid silyl ester obtained by allowing an organic tetracarboxylic acid dianhydride and an N-silylated diamine to react with each other, or the like, in addition to the above-described methods.

Though the foregoing polyether imide can be obtained by a dewatering cyclization reaction between the foregoing diamino compound and an aromatic bisether anhydride such as 2,2,3,3-tetracarboxydiphenylene ether dianhydride, commercially available products, for example, Ultem Resin (manufactured by SABIC Innovative Plastics), Superio Resin (manufactured by Mitsubishi Plastics, Inc.), etc., may also be used.

In the present invention, the porous resin sheet may include, in addition to the thermoplastic resin, an additive according to the necessity. The type of such an additive is not particularly limited, and various additives which are generally used for the foam molding can be used.

Examples of the foregoing additive include a cell nucleating agent, a crystal nucleating agent, a plasticizer, a lubricant, a colorant, an ultraviolet absorber, an antioxidant, a filler, a reinforcing material, a flame-retarding material and an antistatic agent. The additive is not particularly limited in its type and addition amount and can be used within the range where the characteristics of the porous resin sheet according to the present invention are not impaired.

In order to produce the single-layer porous resin sheet according to the present invention, which has a thickness of 1.0 mm or more, a dielectric constant at 1 GHz of 2.00 or less, a dielectric loss tangent of 0.0050 or less, and an elastic modulus of 200 MPa or more, the single-layer porous resin sheet can be produced by using the foregoing thermoplastic resin layer and making this porous. In particular, by forming a porous resin sheet having a porosity of 40% or more, which has cells having an average cell diameter of 5.0 μm or less, the dielectric constant or dielectric loss tangent can be lowered without variation and without causing a reduction of the insulating properties or mechanical strength.

The method for producing a porous resin sheet according to the present invention includes: a gas impregnation step of impregnating a thermoplastic resin composition containing at least a thermoplastic resin with a non-reactive gas under pressure; and after the gas impregnation step, a foaming step of reducing the pressure to foam the thermoplastic resin composition.

The gas impregnation step is a step of impregnating a thermoplastic resin composition containing at least a thermoplastic resin with a non-reactive gas under pressure, and examples of the non-reactive gas include carbon dioxide, a nitrogen gas and air. These gases may be used either alone or in a mixture thereof.

Among these non-reactive gases, the use of carbon dioxide which is high in the impregnation amount into the thermoplastic resin used as a raw material of the foamed body and fast in the impregnation rate is especially preferable.

It is necessary to properly adjust the pressure and temperature at the time of impregnation with a non-reactive gas depending upon the type of the non-reactive gas, the type of the thermoplastic resin or thermoplastic resin composition, and the aimed average cell diameter or porosity of the porous resin sheet. For example, in the case of using carbon dioxide as the non-reactive gas and using a polyimide as the thermoplastic resin, in order to produce a porous resin sheet having an average cell diameter of 5.0 μm or less and a porosity of 40% or more, the pressure is from about 7.4 to 100 MPa, and preferably from 20 to 50 MPa, and the temperature is from about 120 to 350° C., and preferably from about 120 to 300° C. In addition, for example, in the case of using carbon dioxide as the non-reactive gas and using a polyether imide as the thermoplastic resin, in order to produce a porous resin sheet having an average cell diameter of 5.0 μm or less and a porosity of 40% or more, the pressure is from about 7.4 to 100 MPa, and preferably from 20 to 50 MPa, and the temperature is from about 120 to 260° C., and preferably from about 120 to 220° C.

In addition, from the viewpoint of making the impregnation rate into the polymer fast, it is preferable that the foregoing non-reactive gas is in a supercritical state. For example, in the case of carbon dioxide, the critical temperature is 31° C., and the critical pressure is 7.4 MPa. When the carbon dioxide is rendered in a supercritical state where the temperature is 31° C. or higher, and the pressure is 7.4 MPa or more, the solubility of carbon dioxide in the polymer remarkably increases, so that it becomes possible to incorporate it in a high concentration. In addition, when the gas is impregnated in a supercritical state, the gas concentration in the polymer is high. Therefore, when the pressure is abruptly descended, a large amount of cell nuclei are formed, and even if the porosity is identical, the density of cells formed upon the growth of the cell nuclei becomes large, so that very fine cells can be obtained.

In the present invention, the foaming step is a step of after the foregoing gas impregnation step, reducing the pressure to foam the thermoplastic resin composition. By reducing the pressure, a large amount of cell nuclei are formed in the thermoplastic resin composition. Though the degree of reducing the pressure (decompression rate) is not particularly limited, it is from about 5 to 400 MPa/sec.

In the present invention, a heating step of heating the porous resin sheet including a thermoplastic resin composition, in which cell nuclei have been formed in the foaming step, at a temperature of 150° C. or higher may be provided. By heating the porous resin sheet having cell nuclei formed therein, the cell nuclei grow to form cells. The heating temperature is preferably 180° C. or higher, and more preferably 200° C. or higher. When the heating temperature is lower than 150° C., there is a concern that it is difficult to obtain a porous resin sheet having a high porosity. Incidentally, after the heating step, the porous resin sheet may be quenched to prevent the growth of cells or fix the cell shape.

In the present invention, the gas impregnation step of impregnating a thermoplastic resin composition containing at least a thermoplastic resin with a non-reactive gas under pressure and a foaming step of after the gas impregnation step, reducing the pressure to foam the thermoplastic resin composition may be carried out by any system of a batch system or a continuous system.

According to the batch system, for example, the foamed body can be produced in the following manner. That is, by extruding the thermoplastic resin composition containing at least a thermoplastic resin using an extruder such as a single screw extruder and a twin screw extruder, a sheet including the thermoplastic resin as a base material resin is formed. Alternatively, by uniformly kneading the thermoplastic resin composition containing at least a thermoplastic resin using a blade-equipped kneading machine such as a roller, a cam, a kneader and a Banbury type and press molding the resulting composition in a prescribed thickness using a hot plate press or the like, a sheet including the thermoplastic resin as a base material resin is formed. The thus obtained unfoamed sheet is put into a high-pressure vessel, and a non-reactive gas including carbon dioxide or nitrogen, air is injected, thereby impregnating the foregoing unfoamed sheet with the non-reactive gas. At a point of time of sufficiently impregnating the unfoamed sheet with the non-reactive gas, the pressure is released (usually to the atmospheric pressure), thereby forming cell nuclei in the base material resin. Then, after heating the cell nuclei to allow the cells to grow, the cells are abruptly cooled by cold water or the like to prevent the growth of the cells or fix the cell shape, thereby obtaining a heat-resistant polymer foamed body.

On the other hand, according to the continuous system, for example, the non-reactive gas is injected while kneading the thermoplastic resin composition containing at least a thermoplastic resin using an extruder such as a single screw extruder and a twin screw extruder, the resin is sufficiently impregnated with the non-reactive gas, and the resulting resin is then extruded to release the pressure (usually to the atmospheric pressure), thereby forming cell nuclei. Then, after heating the cell nuclei to allow the cells to grow, and the cells are abruptly cooled by cold water or the like to prevent the growth of the cells or fix the cell shape. There can be thus obtained a heat-resistant polymer foamed body.

In the present invention, the porous resin sheet is a single layer and has a thickness of 1.0 mm or more. In the present invention, the single-layer porous resin sheet is one composed of the same thermoplastic resin composition over the whole of the thickness direction of the sheet and does not include, for example, a laminate obtained by sticking a plurality of sheets with an adhesive or adhesive sheet made of a different raw material.

The thickness of the porous resin sheet according to the present invention is 1.0 mm or more, preferably 1.2 mm or more, and more preferably 1.3 mm or more (usually 3.0 mm or less). So far as the thickness of the porous resin sheet is 1.0 mm or more, for example, when used for a mobile phone antenna, there is brought such an advantage that in the antenna characteristics, the reflection characteristic is shifted in a lower direction, and band widening is realized. When the thickness of the porous resin sheet is less than 1.0 mm, an increase of the reflection characteristic or band widening is not obtained.

Incidentally, in the present invention, a variation in the thickness of the porous resin sheet is preferably 10 μM or less, and more preferably 8 μm or less. When the variation in the thickness of the porous resin sheet exceeds 10 μm, there is a concern that a warp or a strain is liable to be generated in the porous resin sheet.

In the present invention, as for the thickness of the porous resin sheet, in a sample of 50 mm×50 mm, the inside of a plane thereof is divided into 25 sections at every 1 cm²; a film thickness of each section is measured with a dial gauge; an average value thereof is designated as the thickness; and a difference between the maximum value and the minimum value is defined as the variation.

In addition, the porous resin sheet according to the present invention has a dielectric constant at 1 GHz of 2.00 or less. So far as the dielectric constant of the porous resin sheet is 2.00 or less, there is brought such an advantage that the wide bandwidth widens at the same thickness of a low dielectric substance. When the dielectric constant exceeds 2.00, the wide bandwidth becomes narrow, and therefore, it becomes necessary to make the thickness of the sheet thick. In the present invention, the dielectric constant at 1 GHz of the porous resin sheet is preferably 1.90 or less, and more preferably 1.85 or less (usually 1.40 or more).

In addition, the porous resin sheet according to the present invention has a dielectric loss tangent of 0.0050 or less. So far as the dielectric loss tangent of the porous resin sheet is 0.0050 or less, there is brought such an advantage that the dielectric loss in a high-frequency region can be reduced. When the dielectric loss tangent exceeds 0.0050, the dielectric loss becomes worse as compared with a resin as a simple substance. In the present invention, the dielectric loss tangent of the porous resin sheet is preferably 0.0045 or less, and more preferably 0.0042 or less.

In the present invention, as for the dielectric constant and dielectric loss tangent of the porous resin sheet, dielectric constant and dielectric loss tangent at a frequency of 1 GHz were measured by the cavity resonator perturbation method. A sample having a size of φ2 mm×70 mm in length was measured using, as a measuring instrument, a cylindrical cavity resonator (“Network Analyzer N5230C”, manufactured by Agilent Technologies, “Cavity Resonator 1 GHz”, manufactured by Kanto Electronic Application and Development Inc.).

In addition, the porous resin sheet according to the present invention has an elastic modulus of 200 MPa or more. When the elastic modulus is less than 200 MPa, there is caused such an inconvenience that deformation is liable to occur at the time of substrate processing. In the present invention, the elastic modulus of the porous resin sheet is preferably 220 MPa or more, and more preferably 240 MPa or more (usually 400 MPa or less).

In the present invention, as for the elastic modulus of the porous resin sheet, the measurement is carried out on the basis of IPC-TM-650, Number 2.4.18.3, and a tensile elastic modulus as calculated from a gradient of the stress curve at a tensile rate of 50 mm/min is adopted.

An average cell diameter of the cells contained in the porous resin sheet according to the present invention is preferably 5.0 μm or less, and more preferably 4.0 μm or less (usually 0.01 μm or more). So far as the average cell diameter of the porous resin sheet is 5.0 μm or less, there is brought such an advantage that the dielectric constant and the dielectric loss tangent can be made low without lowering the insulating properties or mechanical strength. When the average cell diameter of the porous resin sheet exceeds 5.0 μm, there is a concern that the insulating properties or mechanical strength is lowered.

As for the average cell diameter of the cells contained in the porous resin sheet according to the present invention, a cutting plane of the porous resin sheet was observed by a scanning electron microscope (SEM) (“S-3400N”, manufactured by Hitachi, Ltd.), an image thereof was then subjected to a binarization treatment with an image processing software (“Win ROOF”, manufactured by Mitani Corporation), thereby separating a cell part and a resin part from each other, and a maximum vertical chord length of the cells was measured. With respect to fifty cells having a larger cell diameter, an average value thereof was taken and defined as the average cell diameter.

In addition, a porosity of the porous resin sheet according to the present invention is preferably 40% or more, more preferably 50% or more, and especially preferably 60% or more (usually 80% or less). So far as the porosity of the porous resin sheet is 40% or more, the sheet is in a state where uniform pores are present within the sheet, thereby bringing about such an advantage that the dielectric characteristics have no variation. When the porosity of the porous resin sheet is less than 40%, there is a concern that the pore-forming state goes unbalanced, so that a variation in the dielectric characteristics is liable to occur.

The porosity of the porous resin sheet according to the present invention is determined by measuring a specific gravity of each of the thermoplastic resin composition before foaming and the porous resin sheet after foaming and calculating a ratio thereof {(specific gravity of the thermoplastic resin composition before foaming)/(specific gravity of the porous resin sheet after foaming)}.

In addition, it is desirable that the porous resin sheet according to the present invention has a tensile strength (breaking strength) of from 8 to 20 MPa, and preferably from 10 to 15 MPa. So far as the tensile strength falls within the range of from 8 to 20 MPa, in the case where the porous resin sheet according to the present invention is used for a circuit board, a mobile phone antenna, an electromagnetic wave control material, a heat insulating material, or the like, it has a sufficient strength and is able to obtain stable dielectric characteristics. On the other hand, when the tensile strength is less than 8 MPa, in the case where the porous resin sheet is used for the foregoing applications, there is a concern that it may be impossible to obtain a sufficient strength. In addition, the cell diameter becomes large, and therefore, there is a concern that the dielectric characteristics have variation. In addition, when the tensile strength exceeds 20 MPa, the pore formation is not sufficiently accomplished, and there is a concern that low dielectric constant and dielectric loss tangent are not obtained.

In addition, it is desirable that the porous resin sheet according to the present invention has a tensile elongation (breaking elongation) of from 2.0 to 4.0%, and preferably from 2.5 to 3.5%. So far as the tensile elongation falls within the range of from 2.0 to 4.0%, in the case where the porous resin sheet according to the present invention is used for a circuit board, a mobile phone antenna, an electromagnetic wave control material, a heat insulating material, or the like, it has sufficient shape stability without causing deformation or the like and is able to obtain stable dielectric characteristics. When the tensile elongation is less than 2.0%, the pore formation is not sufficiently accomplished, and there is a concern that low dielectric constant and dielectric loss tangent are not obtained. In addition, when the tensile elongation exceeds 4.0%, in the case where the porous resin sheet is used for the foregoing applications, there is a concern that deformation or the like occurs. In addition, the cell diameter becomes large, and therefore, there is a concern that the dielectric characteristics have variation.

In the present invention, the tensile strength and tensile elongation of the porous resin sheet were measured on the basis of IPC-TM-650, Number 2.4.18.3 and determined from strength and elongation at break at a tensile rate of 50 mm/min, respectively.

The porous resin sheet according to the present invention is able to have solder heat resistance in view of the fact that the thermoplastic resin having heat resistance is used. The solder heat resistance is evaluated by floating the porous resin sheet in a solder reflow heated at 260° C. for 30 seconds and observing the presence or absence of any change.

The porous resin sheet according to the present invention can be formed into a porous substrate by forming a metal foil layer on at least one surface thereof. The porous substrate is used as a mobile phone antenna or antenna substrate, a high-frequency circuit board, or an electromagnetic wave control material such as an electromagnetic wave shield and an electromagnetic wave absorber. In particular, the porous substrate is favorably used as a patch antenna which is used for mobile phone antennas and the like.

Though the metal foil is not particularly limited, in general, a stainless steel foil, a copper foil, an aluminum foil, a copper-beryllium foil, a phosphor bronze foil, an iron-nickel alloy foil, and the like are used. Though a method for forming a metal foil layer is not particularly limited, examples thereof include (1) a method in which a resin layer to be foamed is formed on a base material composed of a metal foil, followed by foaming this; (2) a method in which an foamed resin layer is fabricated in advance and then metallized by a known method such as sputtering, electrolytic plating, electroless plating, etc.; and the like. In addition, a combination of two or more methods thereof can also be adopted.

### EXAMPLES

The present invention is hereunder described by reference to the following Examples, but it should be construed that the present invention is not limited to these Examples at all.

### [Measurement and Evaluation Methods]

### (Dielectric Constant and Dielectric Loss Tangent)

Dielectric constant and dielectric loss tangent at a frequency of 1 GHZ were measured by the cavity resonator perturbation method. A sample having a size of φ2 mm×70 mm in length was measured using, as a measuring instrument, a cylindrical cavity resonator (“Network Analyzer N5230C”, manufactured by Agilent Technologies, “Cavity Resonator 1 GHz”, manufactured by Kanto Electronic Application and Development Inc.).

### (Thickness and Variation in Thickness)

A sample of 50 mm×50 mm was collected from a porous resin sheet; the inside of a plane thereof was divided into 25 sections at every 1 cm²; a film thickness of each section was measured with a dial gauge (“R1-205”, manufactured by Ozaki Mfg. Co., Ltd.); an average value thereof was designated as the thickness; and a difference between the maximum value and the minimum value was defined as the variation.

### (Average Cell Diameter)

A porous resin sheet was cooled with liquid nitrogen and cut vertically against the sheet plane using a blade, thereby fabricating an evaluation sample. The cutting plane of the sample was subjected to an Au vapor deposition treatment, and the resulting cutting plane was observed by a scanning electron microscope (SEM) (“S-3400N”, manufactured by Hitachi, Ltd.). An image thereof was then subjected to a binarization treatment with an image processing software (“Win ROOF”, manufactured by Mitani Corporation), thereby separating a cell part and a resin part from each other, and a maximum vertical chord length of the cells was measured. With respect to fifty cells having a larger cell diameter, an average value thereof was taken and defined as the average cell diameter.

### (Porosity)

A specific gravity of a thermoplastic resin composition before foaming and a porous resin sheet after foaming was measured using a densimeter (“MD-300S”, manufactured by Alfa Mirage Co., Ltd.), and a porosity was calculated from a ratio thereof {(specific gravity of the thermoplastic resin composition before foaming)/(specific gravity of the porous resin sheet)}.

### (Mechanical Physical Properties)

Mechanical physical properties (elastic modulus, tensile strength, and tensile elongation) of the porous resin sheet were calculated from a stress curve obtained at a tensile rate of 50 mm/min using a tensile and compression testing machine (“Techno Graph TG-100 kN”, manufactured by Minebea Co., Ltd.) in accordance with IPC-TM-650, Number 2.4.18.3.

### (Solder Heat Resistance)

The solder heat resistance was evaluated by floating a porous resin sheet in a solder reflow heated at 260° C. for 30 seconds and observing the presence or absence of any change.

O: No change

X: Change in appearance or external shape such as shrinkage, fusion, etc.

### Example 1

A polyether imide resin (a trade name: “Ultem 1000”, manufactured by SABIC Innovative Plastics, Tg: 217° C., specific gravity: 1.27) was formed into a single-layer sheet having a thickness of 0.8 mm by using a twin screw extruder. The unfoamed single-layer sheet was put into a 500-cc pressure vessel and impregnated with carbon dioxide by keeping the inside of the vessel in a carbon dioxide atmosphere at 120° C. and 25 MPa for 5 hours. Thereafter, this sheet was returned to the atmospheric pressure at a rate of 300 MPa/sec and then allowed to continuously pass through an oil bath at 210° C. for 60 seconds, thereby allowing cells to grow. The resulting sheet was quickly taken out and then abruptly cooled with ice-mixed water, thereby obtaining a 1.81 mm-thick porous resin sheet composed of a polyether imide.

### Example 2

A polyether imide resin (a trade name: “Ultem 1000”, manufactured by SABIC Innovative Plastics) was formed into a single-layer sheet having a thickness of 0.8 mm by using a twin screw extruder. The unfoamed single-layer sheet was put into a 500-cc pressure vessel and impregnated with carbon dioxide by keeping the inside of the vessel in a carbon dioxide atmosphere at 210° C. and 25 MPa for one hour. Thereafter, this sheet was returned to the atmospheric pressure at a rate of 300 MPa/sec, thereby obtaining a 1.55 mm-thick porous resin sheet composed of a polyether imide.

### Comparative Example 1

A 0.065 mm-thick porous resin sheet composed of a polyether imide was obtained in the same manner as that in Example 1, except for using a single-layer sheet having a thickness of 0.035 mm. Ten sheets of this porous resin sheet were laminated with an epoxy adhesive sheet (“B-EL10#40”, manufactured by Nitto Shinko Corporation) and treated by an autoclave under a condition at 150° C. and 15 kg/cm² for 3 hours, thereby fabricating a laminated sheet having a thickness of 1.01 mm.

TABLE 1

| | | | | Comparative |
|---|---|---|---|---|
| | | Example 1 | Example 2 | Example 1 |
| Dielectric constant | | 1.81 | 1.73 | 1.90 |
| (at 1 GHz) | | | | |
| Dielectric loss tangent | | 0.0040 | 0.0030 | 0.0320 |
| (at 1 GHz) | | | | |
| Thickness | (mm) | 1.81 | 1.55 | 1.01 |
| Variation in | (μm) | 7 | 5 | 17 |
| thickness | | | | |
| Pore diameter | (μm) | 4.0 | 3.0 | 5.0 |
| Porosity | (%) | 65% | 71% | 72%* |
| Tensile elastic | (MPa) | 280 | 260 | 190 |
| modulus | | | | |
| Tensile strength | (MPa) | 12.3 | 11.0 | 7 |
| Tensile elongation | (%) | 3.3 | 2.9 | 2.8 |

| | | | |
|---|---|---|---|
| Solder heat resistance | ◯ | ◯ | ◯ |
| (260° C. × 30 seconds) | (No change) | (No change) | (No change) |

*The porosity of Comparative Example 1 was measured with respect to the porous resin sheet before lamination.

In view of the fact that the porous resin sheets of Examples 1 and 2 are an adhesive layer-free single-layer porous resin sheet, they are able to accomplish characteristics such that they keep low dielectric constant with a dielectric constant of 2.00 or less and a dielectric loss tangent of 0.0050 or less, have high stiffness (elastic modulus) and no variation in the thickness, and also keep the solder heat resistance. On the other hand, though the porous resin sheet of Comparative Example 1 has a low dielectric constant, in view of the fact that the lamination was performed via an adhesive layer, it is inferior in the stiffness and dielectric loss tangent.

### (Simulation of Antenna Characteristics)

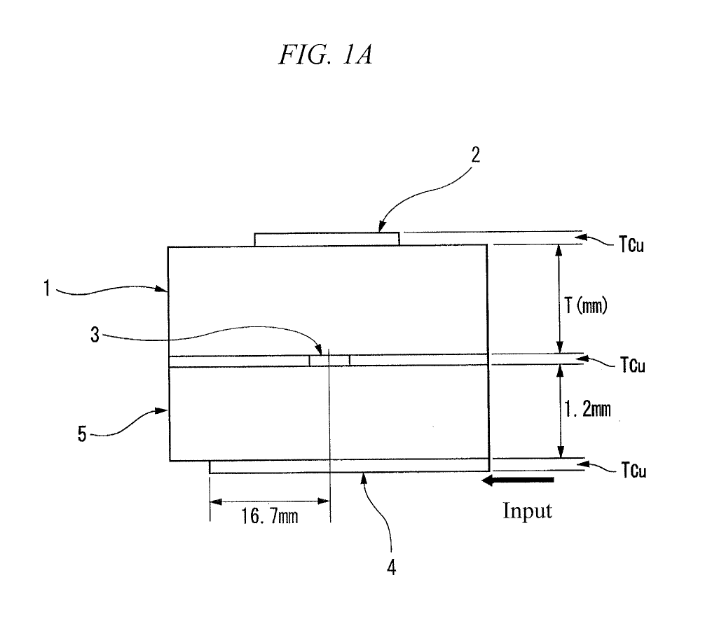

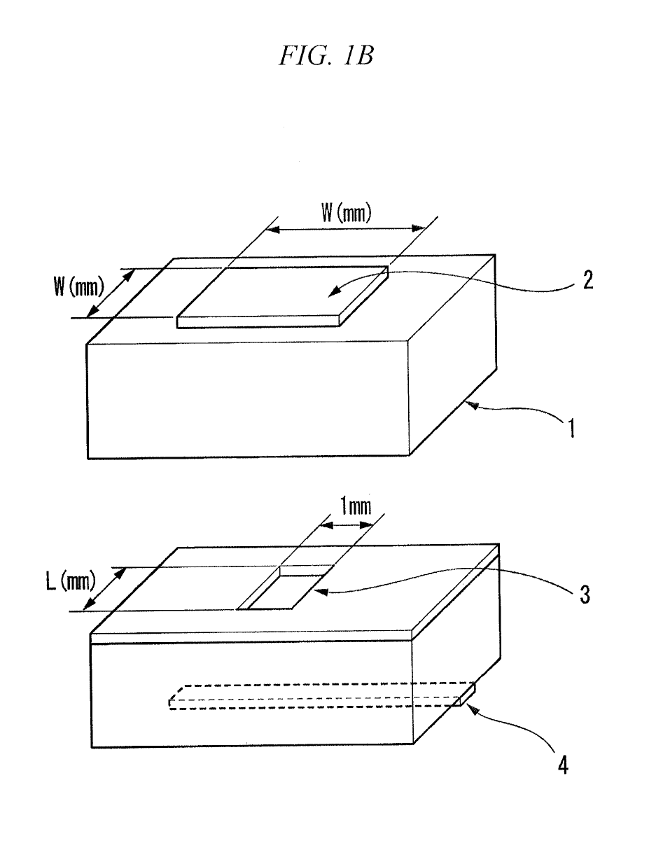

With respect to the bandwidth and antenna characteristics in the case of applying the porous resin sheet according to the present invention to a patch antenna, a simulation analysis by “MW STUDIO”, manufactured by CST was carried out. An analysis model of the patch antenna was carried out by a configuration shown in FIGS. 1A and 1B. FIG. 1A is a lateral view and is an explanatory view at the time of seeing the configuration of the simulated patch antenna. In addition, FIG. 1B is a single view drawing and is an oblique view at the time of seeing the configuration of the simulated patch antenna from an obliquely upper part. In order to facilitate one to easily understand the positional relation of a slot, FIG. 1B is shown as an image drawing of dividing at a portion of a porous resin sheet 1 and floating it upwardly.

In order to make influences of a power supply portion identical with each other as far as possible, the patch antenna of the simulation model is formed as a double-layer structure via a slot 3, and the power supply into the antenna is not direct power supply but is carried out by means of electromagnetic coupling via the slot 3. A substrate 5 on the side of foaming a microstrip line 4 was made to have a thickness of 1.2 mm, a dielectric constant of 4.3, and a dielectric loss tangent of 0. A conductor of each layer was formed of Cu and made to have a thickness T_{Cu} of 10 μm.

The analysis of each of the bandwidth and the antenna characteristics by the simulation was carried out by changing the substrate material on the side of a patch antenna element 2. Each size is adjusted as shown below such that the antenna generates resonance in the vicinity of 2.4 GHz relative to the substrate material on the side of each antenna element (see Table 2). For reference, the results of simulation regarding a fluorine resin and a ceramic, each of which is used for a substrate of the conventional patch antenna, are also described.

TABLE 2

| | | Dielectric | | | | Center |
|---|---|---|---|---|---|---|
| Substrate | Dielectric | loss | T | L | W | frequency |
| material | constant | tangent | [mm] | [mm] | [mm] | [GHz] |
| Example 1 | 1.81 | 0.0040 | 1.81 | 15 | 42 | 2.41 |
| Example 2 | 1.73 | 0.0030 | 1.55 | 15 | 43 | 2.41 |
| Comparative | 1.90 | 0.0320 | 1.01 | 15 | 41 | 2.4 |
| Example 1 | | | | | | |
| Fluorine | 2.6 | 0.001 | 1.60 | 15 | 34 | 2.44 |
| resin | | | | | | |
| Ceramic | 9.5 | 0.0005 | 1.60 | 8 | 18 | 2.47 |

The bandwidth at −6 dB and the antenna radiation characteristics (directional gain and absolute gain at 1 mm) at each resonance frequency as determined from a return loss by the simulation were analyzed. The results are shown in Table 3.

TABLE 3

| Substrate | Bandwidth at −6 dB | Directional gain | Absolute gain |
|---|---|---|---|
| material | [MHz] | [dB] | [dB] |
| Example 1 | 75 | 8.17 | 7.31 |
| Example 2 | 72 | 8.26 | 7.43 |
| Comparative | 105 | 8.04 | 2.4 |
| Example 1 | | | |
| Fluorine resin | 63 | 7.56 | 7.04 |
| Ceramic | 33 | 6.44 | 5.62 |

It is understood from the foregoing results that by applying the porous resin sheet according to the present invention to a patch antenna element, a patch antenna having wide bandwidth and high antenna characteristics can be fabricated.

While the invention has been described in detail and with reference to specific embodiments thereof, it will be apparent to one skilled in the art that various changes and modifications can be made therein without departing from the spirit and scope thereof.

The present application is based on Japanese Patent Application No. 2010-203806 filed on Sep. 11, 2010 and Japanese Patent Application No. 2011-189696 filed on Aug. 31, 2011, the contents of which are incorporated herein by reference.

### INDUSTRIAL APPLICABILITY

The porous resin sheet according to the present invention can be utilized as a substrate material over a wide range inclusive of low-dielectric constant materials which are used for high-frequency circuits, such as circuit boards and mobile phone antennas, electromagnetic wave control materials such as electromagnetic wave shields and electromagnetic wave absorbers, heat insulating bodies, and the like while applying characteristics including thick film thickness, low dielectric constant and dielectric loss tangent, and high elastic modulus. In particular, the porous resin sheet according to the present invention can be used as a patch antenna element substrate material having wide bandwidth and high antenna characteristics.

### DESCRIPTION OF REFERENCE NUMERALS AND SIGNS

1: Porous resin sheet
2: Patch antenna element
3: Slot
4: Microstrip line
5: Substrate

1. A porous resin sheet which is a single-layer porous resin sheet comprising a thermoplastic resin,
wherein the porous resin sheet has a thickness of 1.0 mm or more, a dielectric constant at 1 GHz of 2.00 or less, a dielectric loss tangent of 0.0050 or less and an elastic modulus of 200 MPa or more.

2. The porous resin sheet according to claim 1, containing cells having an average cell diameter of 5.0 μm or less, so as to have a porosity of 40% or more.

3. The porous resin sheet according to claim 1, wherein a variation in the thickness of 10 μm or less.

4. The porous resin sheet according to claim 1, wherein the thermoplastic resin is any one kind selected from a polyimide and a polyether imide.

5. A method for producing the porous resin sheet according to claim 1, the method comprising:
A gas impregnation step of impregnating a thermoplastic resin composition containing at least a thermoplastic resin with a non-reactive gas under pressure; and
After the gas impregnation step, a foaming step of reducing the pressure to foam the thermoplastic resin composition.

6. The method for producing a porous resin sheet according to claim 5, the method including, after the foaming step, a heating step of heating the porous resin sheet at a temperature of 150° C. or higher.

7. The method for producing a porous resin sheet according to claim 5, wherein the non-reactive gas is carbon dioxide.

8. The method for producing a porous resin sheet according to claim 5, wherein the non-reactive gas is impregnated in a supercritical state.

9. A porous substrate comprising a metal foil layer on at least one surface of the porous resin sheet according to claim 1.
